(19) United States
(12) Patent Application Publication
(10) Pub. No.: US 2005/0172141 A1
(43) Pub. Date: Aug. 4, 2005

(54) Method and apparatus for wireless management of mobile entities

(76) Inventors: Ruth Schaefer Gayde, Naperville, IL (US); Victoria Marie Halsell, Aurora, IL (US); Cynthia Florkey, Chicago, IL (US); Karla Rae Hunter, Naperville, IL (US); E-Ling Lou, Naperville, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/768,537

(22) Filed: Jan. 30, 2004

(51) Int. Cl. H04L 9/32

(52) U.S. Cl. 713/191

(57) ABSTRACT

This invention relates to a method and apparatus for wireless management of mobile entities. More particularly, the invention relates to an end user device which will allow a trusted entity, e.g., a service provider, to repair the end user device in the event that the end user device becomes inoperable. In addition, the method allows for the trusted entity to update the end user device. Notably, the trusted entity is able to accomplish these tasks from a remote location using an air interface, e.g., a wireless connection.

### BACKGROUND OF THE INVENTION

This invention relates to a method and apparatus for wireless management of mobile entities. More particularly, the invention relates to an end user device which will allow a trusted entity, e.g., a service provider, to repair the end user device in the event that the end user device becomes inoperable. In addition, the method allows for the trusted entity to update the end user device. Notably, the trusted entity is able to accomplish these tasks from a remote location using an air interface, e.g., a wireless connection.

While the invention is particularly directed to the art of mobile management, and will thus be described with specific reference thereto, it will be appreciated the invention may have usefulness in other fields and applications. For example, the invention may be used in the application where wireless management of a mobile entity is desired.

By way of background, if there is a problem with an end user device such as a mobile phone, the device must typically be taken into the customer service center for human intervention. There is currently no known technology to run diagnostics and resolve problems on an end user device from a remote location.

This drawback to current technology is increasingly problematic because, as mobile devices become more complex, users are able to download more software programs from sources other than the service provider for the wireless service. As such, the wireless service provider is not necessarily capable of repairing the phone. Accordingly, it is desired to allow third party trusted entities to repair and/or update the mobile device. It is also desired that such trusted entities possess the proper tools to diagnose and repair the device, given the potential multitude of problems that could arise as a result of downloaded software.

Over-The-Air Parameter Administration (OTAPA) allows a service provider to automatically download preferred roaming lists to a mobile phone. In addition, Over-The Air Service Provisioning (OTASP) allows a user to initiate a session with a customer care center to activate a mobile phone. Still further, an application called NetMeetings allows an external party to take control of a Microsoft Windows application.

However, this known technology lacks the ability of a trusted entity to remotely repair a mobile station that has become inoperable or provide software updates. Consequently, proper tools for update and/or repair are not available. As such, as noted above, a system that allows for remotely repairing and/or upgrading a mobile station by a trusted entity is desired.

In addition, U.S. Pat. No. 6,308,061 B1 to Criss, et al., issued Oct. 23, 2001, and entitled Wireless Software Upgrades with Version Control, relates to a system that implements wireless software upgrades. The teachings of that patent relate generally to wireless software upgrades provided to mobile devices upon detecting that software currently in the mobile device is outdated. However, the upgrades in this patent are provided by only a single service provider. Moreover, although automatic software updates are provided, this prior patent does not allow for a customer service person to troubleshoot problems. These steps of update are apparently predetermined. For example, no interaction between a customer service representative and a user could occur to de-bug an executable program. In this regard, this prior patent does not allow for the maintenance of two calls between the user and the service provider during the upgrade. In addition, specific authentication steps are not described in the prior patent nor is the concept of saving memory contents, running updates and then restoring the memory contents.

The present invention contemplates a new and improved method and apparatus for wireless management of mobile entities that resolves the above-referenced difficulties and others.

### SUMMARY OF THE INVENTION

A method for wireless management of mobile entities is provided.

In one aspect of the invention, the method comprises signaling a trusted entity to initiate a repair session by user entity requiring repair, obtaining user data on the user entity by the trusted entity, authenticating the repair session, establishing a speech path between the user entity and the trusted entity, establishing a data path between the user entity and the trusted entity, performing diagnostics on the user entity, obtaining repair data based on the diagnostics, repairing the user entity, releasing the data path, and, releasing the speech path.

In another aspect of the invention, the method comprises signaling a trusted entity to initiate an update session by a user entity requiring update, obtaining user data on the user entity by the trusted entity, authenticating the update session, establishing a speech path between the user entity and the trusted entity, establishing a data path between the user entity and the trusted entity, obtaining update data, downloading data to the user entity, executing the data downloaded to the user entity, determining whether further update data should be downloaded, restoring data on the user entity, releasing the data path, and, releasing the speech path.

In another aspect of the invention, these methods are implemented using corresponding means.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 provides a view of a system into which the present invention may be incorporated;

FIG. 2 is an illustration of a user entity according to the present invention;

FIG. 3 illustrates a trusted entity according to the present invention;

FIG. 4 is a call flow according to the present invention;

FIG. 5 is a call flow according to the present invention; and,

FIG. 6 is a call flow according to the present invention.

### DETAILED DESCRIPTION OF THE PREFERRED EMBODIMENTS

Referring now to the drawings wherein the showings are for purposes of illustrating the preferred embodiments of the invention only and not for purposes of limiting same, FIG. 1 provides a view of a system 10 into which the present invention may be incorporated. As shown, the system 10 includes a user entity (UE) 12 that communicates via an air interface with a network 14. Network 14 includes a switching element or module 16 such as a mobile switching center (MSC), a call session control function (CSCF), a Gateway GPRS (General Packet Radio Service) Service Node (GGSN) or a Serving GPRS (General Packet Radio Service) Service Node (SGSN). A trusted entity (TE) 18 is shown communicating with the network 14 and also with an application server (AS) 20 and a database (DB) 22.

It should be appreciated that the user entity (UE) 12 could take the form of a variety of different mobile communication devices. For example, the user entity could be a mobile phone, a personal digital assistant (PDA), a pager, or a personal computer having a wireless interface. As will be described, however, the user entity (UE) 12 preferably takes a form that will achieve the objectives of the invention.

The network 14, while shown as only having single switching entity 16 therein, typically includes a variety of other network elements that are well known in the art and not shown in FIG. 1. For purposes of this invention, the switching element or module 16 represents a pipeline for messaging between the trusted entity (TE) 18 and the user entity (UE) 12.

The trusted entity 18 is shown as a single block. However, it should be appreciated that the trusted entity may comprise multiple trusted entities (for example, as provided by a mobile service provider or a third party application provider) that may be accessed for download of specific applications or consulted relative to particular repairs to the system. The trusted entity, which will be described in more detail below, may take a variety of forms in accord with the present invention. It may be comprised of software running on an application server controlled by, for example, a wireless service provider, a third-party software provider, or the manufacturer of the mobile device.

The application server 20 may take a variety of forms to accomplish the objectives of the present invention. Typically, the application server (AS) 20 will be controlled by a software provider, either the wireless service provider for the user, a third party provider of downloaded software or the mobile device manufacturer. The application server (AS) 20 preferably operates to facilitate the updating of software on a user entity, as will be described. Likewise, the database 22 may take forms well known in the art that allow data to be stored therein in a format conducive to implementation of the present invention. The types of data stored in the database 22 are described, by example, below.

As will also be described in greater detail below, the system 10 allows a user entity (UE) 12 to be repaired or updated by the trusted entity (TE) 18 upon initiation of a repair/update session by the user entity (UE) 12. Of course, the user entity (UE) 12 and the trusted entity (TE) 18 are authenticated to participate in the session. The trusted entity utilizes information it receives from the application server (AS) 20 and the database (DB) 22 to effect repairs and upgrades (or updates) to the user entity (UE) 12. These functions of repair and update are accomplished remotely and wirelessly, a combination of features not heretofore known.

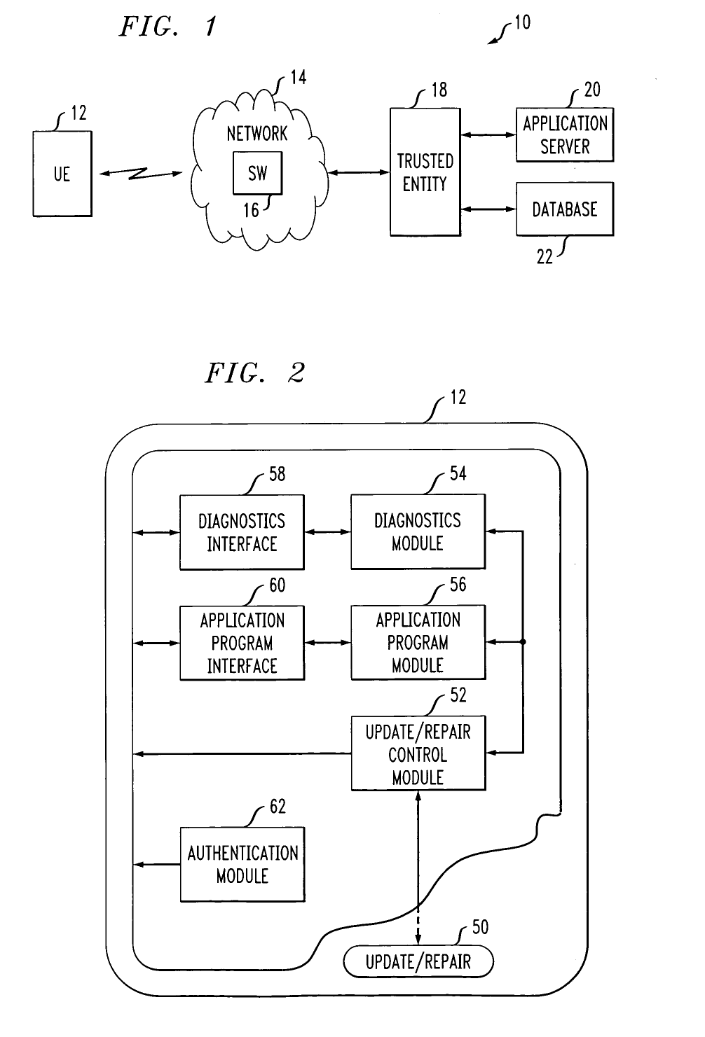

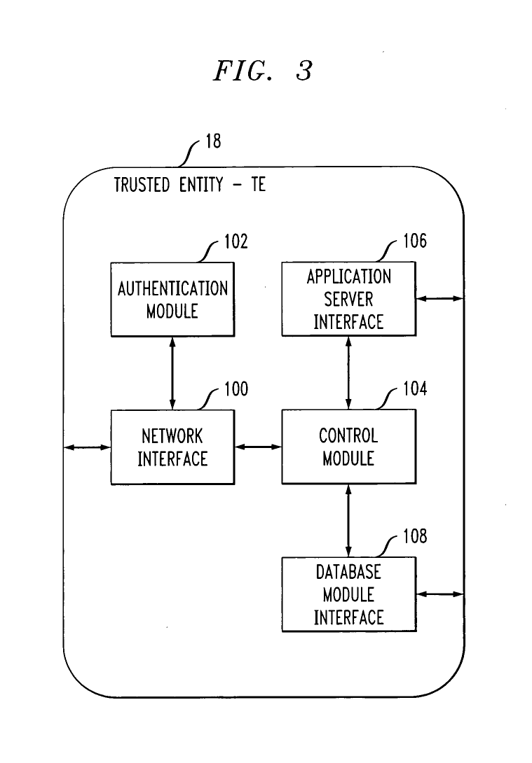

Referring now to FIG. 2, the user entity (UE) 12 according to the present invention is schematically illustrated. As shown, user entity (UE) 12 includes an update repair button 50 and an update/repair control module 52. Also shown within the user entity (UE) 12 are a diagnostics module 54, application program module 56, diagnostics interface 58, application program interface 60 and an authentication module 62. It will be appreciated that the elements of the user entity (UE) 12 may vary. In addition, the modules and interfaces within the user entity (UE) 12 may be implemented using suitable software and hardware techniques. For example, the interfaces 58 and 60 preferably take the form of air interfaces that receive signals and convert those signals to instructions to run the software forming the modules 54 and 56, respectively. The diagnostics and application program routines of the modules 54 and 56 are well known to those skilled in the art. It should further be understood that the interfaces 58 and 60, and the authentication module 62, may all operate through the same radio frequency (rf) interface on the mobile device. Moreover, it should be appreciated that the user entity (UE) 12 will typically include a variety of other elements and functionality that are not described herein. These elements and functionality would, of course, differ depending on its actual form. For example, the elements of the user entity (UE) 12 would be different if it took the form of a mobile phone versus a personal computer or a personal digital assistant (PDA).

Nonetheless, the update/repair button 50 is preferably a hard key that can be pressed by the user upon a determination that the phone is inoperable. It should be appreciated that the button 50 may also be provided in the form of a soft key; however, the soft key may have limitations in the event that inoperability of the display of the phone and the appropriate application program do not allow for display and functioning of the key. It should be further understood that the update/repair button 50 may also be pressed by the user in the event that the user wishes to request an update to the software of the user entity (UE) 12.

In operation, when a user initiates a repair session using the update/repair button 50, the update/repair control module 52 responds by sending a signal out to the network (i.e. trusted entity (TE) 18) indicating that a repair is needed on user entity (UE) 12. In the case of an actual repair, the diagnostics interface 58 serves to allow the trusted entity (TE) 18 to access the user entity (UE) 12. Of course, this will preferably only occur after proper authentication of the user entity (UE) 12 and the trusted entity (TE) 18 has taken place, using established techniques via the authentication module 62 and the corresponding authenticating mechanism within the trusted entity (TE) 18. The diagnostics can then be run on the user entity (UE) 12 through user of the diagnostics module 54 using techniques that will be apparent to those skilled in the art. Notably, the diagnostics interface 58 and the diagnostics module 54 are insulated from all other aspects of the operation of the phone. This is a feature provided to allow for the diagnostics and repair to be accomplished even if the phone is otherwise inoperable. Of course, the only requirements are that the user entity be powered “on” and that the link within the phone from the rf interface to the diagnostics module be intact so that the diagnostics interface 58 and diagnostics module 54 can operate once communication is established with the trusted entity (TE) 18. Once the diagnostics routine is commenced, the only control that the user has over the process is to cancel the process. This can be accomplished a number of ways. For example, the user may simply depress the update repair button a second time to cancel the process.

In the event of a user request for a software update, the process is similar. However, once communication is established with the trusted entity (TE) 18, the application program interface 60 receives the update information and provides the update to the application program module 56. This allows for updating of the software through known techniques and/or techniques tailored to the program being updated.

Referring now to FIG. 3, an illustration of the trusted entity (TE) 18 is shown. The trusted entity (TE) 18 may take a variety of forms. Preferably, however, the trusted entity (TE) 18 comprises a combination of routines or tools implemented on a server controlled by a wireless service provider, a third-party software, or a mobile device manufacturer. The trusted entity (TE) 18 includes an appropriate combination of hardware and software to send, receive and process data and/or programs as will be described below. In this regard, the trusted entity (TE) 18 includes a network interface 100, authentication module 102, control module 104, an application server interface 106 and a database module interface 108. The interfaces 100, 106 and 108 preferably comprise ports that allow for the efficient transfer of data and programs to and from the network, application server, and database module, respectively. These interfaces may also comprise routines or tools that facilitate communication with the control module to carry out the objectives of the invention. The control module comprises software routines to perform the functions recited herein. Likewise, the authentication module performs its functions as is known.

Of course, upon receiving a request from a mobile phone for update or repair at the network interface 100, the authentication module 102 operates to authenticate the request in conjunction with the authentication module 62. That is, these authentication modules operate in known manners to ensure that each end point (e.g. the user entity (UE) 12 and the trusted entity (TE) 18) makes sure that the other end point is who it says that it is. Once the request is authenticated, control module 104 is engaged to run diagnostics, repair the user entity and/or update the appropriate software. The control module 104 accomplishes these tasks by accessing the application server through the application server interface 106 and by accessing the database 22 through the database module interface 108.

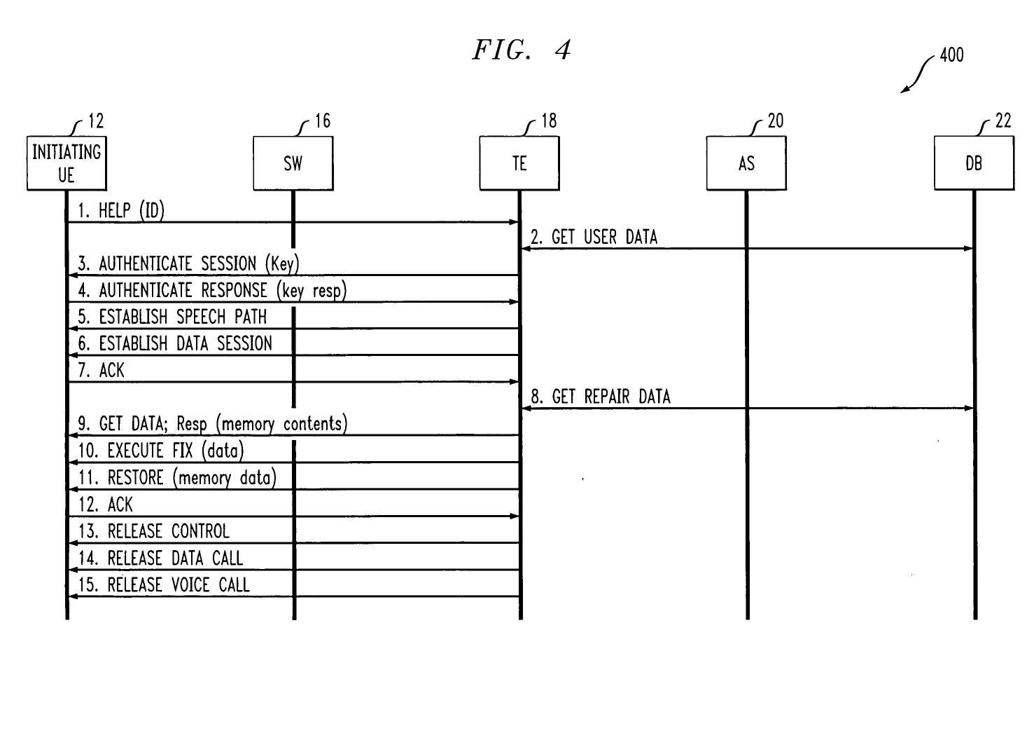

Referring now to FIG. 4, a call flow 400 is illustrated. This call flow 400 relates to the situation where a user's device (e.g., a PDA, mobile phone, or PC) becomes un-useable or inoperable. To implement a process that addresses this situation according to the present invention, the end-user depresses or manipulates a special button (e.g., update/repair button 50) on the device. As noted above, this button could be a soft key or a hard key on the device. Once depressed or manipulated, the user entity (UE) 12 (through update/repair control module 52) sends a “help” message to the trusted entity (TE) 18 (at line 1). The Help message or signal contains data identifying the user identity (UE) 12 (IP address, MIN, IMSI, etc.). The destination of the trusted entity (TE) 18 is preferably programmed into the user entity (UE) 12 and, where multiple trusted entities are involved, may be selected by the user from, for example, a menu display.

Once the help signal is received through the network interface 100, the trusted entity (TE) 18 accepts the help message, and accesses the profile database 22 through the control module 104 and database module interface 108 to obtain information about the user entity (UE) 12 (at line 2). This could be information such as manufacturer identity, user entity type, user contact information and/or authentication key information.

The trusted entity (TE) 18 then authenticates the user entity (UE) (at line 3) as described above through the authentication module 102. Of course, as noted above, this process is well known in the art and is implemented in many wireless communication sessions.

The user entity (UE) 12 sends an authentication response through authentication module 62. Of course, this is also well known in the art (at line 4). The reason for authentication in this manner is for security and identity purposes—so the user entity (UE) 12 can validate that the trusted entity (TE) 18 is actually trusted.

The trusted entity (TE) 18 then establishes a voice session, if possible, with the user entity (UE) 12 through the control module 104 (at line 5). It should be appreciated that the routines in the control module allow for interaction of a customer service representative on the voice channel, if necessary. The directory number (DN) of the user entity (UE) 12 could be any phone, including the user entity (UE) that is un-useable. If the trusted entity (TE) 18 cannot reach the user entity (UE) 12 by voice channel, the control module 104 of the trusted entity (TE) 18 may elect to establish a data session to repair the voice path to the user entity (UE) 12 (at line 6). Once the voice path is established, the trusted entity (TE) 18 can contact the user (by way of a customer service representative or in an automated manner) and determine if other fixes are needed.

At the commencement of the repair process (which may be implemented at various times and is not limited to a predetermined schedule), the user entity (UE) 12 will acknowledge a working data session (at line 7).

The trusted entity (TE) 18 will access the database 22 through the control module 104 and interface 108 to extract diagnostic tools for this user entity (UE) 12 (at line 8). This step can be performed at any point in the session, and may be performed multiple times.

The trusted entity (TE) 18 and the user entity (UE) 12 will communicate, so the trusted entity (TE) 18 can extract data from the user entity (UE) 12 through the diagnostics interface 58 (at line 9). This will include (but is not limited to) extracting user database information which will be preserved and can later be re-installed, if needed, and the contents of memory (e.g. state information, last known operation, etc.).

The trusted entity (TE) 18 will perform a series of steps to repair the user entity (UE) 12 through the diagnostics module 54 and interface 58. This could include downloading data/executables to the user entity (UE) 12 (at line 10).

Once the user entity (UE) 12 is considered restored, the trusted entity (TE) 18 will repopulate the saved user data (at line 11).

The user entity (UE) 12 will acknowledge the successful data download (at line 12).

The trusted entity (TE) will then release control of the user entity (UE) 12 (at line 13). At this point, the user can gain control of the user entity (UE) 12.

The trusted entity (TE) 18 will also remove the voice connections—ending the voice connection could happen at any time (at line 15).

The trusted entity (TE) 18 will also remove the data connections (at line 14).

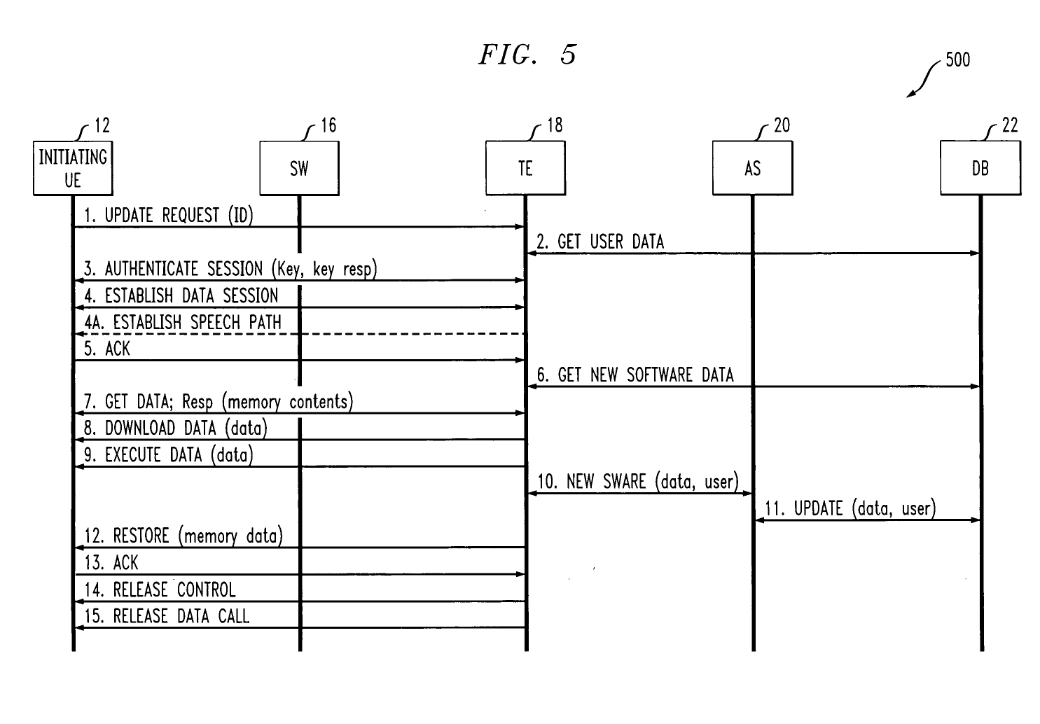

Referring to FIG. 5, a call flow 500 is illustrated. This call flow relates to the situation where a user requests that the latest software release(s) be downloaded to her user device (e.g. a PDA, mobile phone, PC), or user entity (UE) 12. The end-user hits a special button on the device (e.g. button 50). Again, this button could be a soft button or a physical key on the device. Once depressed or manipulated, the user entity (UE) 12 (through update/repair control module 52) sends an “update request” message to the trusted entity (TE) 18 (at line 1). The “update request” contains data identifying the user entity (UE) 12 (IP address, MIN, IMSI, etc.) and device information (manufacturer, release). The destination of the trusted entity (TE) 18 is preferably programmed into the user entity (UE) 12 and, where multiple trusted entities are involved, may be selected by the user from, for example, a menu display.

The trusted entity (TE) 18 accepts the update request message through its network interface 100, and accesses the database 22 via the control module 104 and database interface 108 to obtain information about the user entity (UE) 12 (at line 2). This could be information such as manufacturer information, model information, user entity type, current software release information and/or authentication key information.

The trusted entity (TE) 18 authenticates the session with the user entity (UE) 12 and the user entity (UE) 12 responds (at line 3). Of course, this is accomplished via authentication modules 62 and 102.

The trusted entity (TE) 18 establishes a data session, through control of the control module 104, on which to perform the download to the user entity (UE) (at line 4). It should be appreciated that a speech path may also be established to provide communication between the trusted entity (TE) 18 and the user entity (UE) 12 (at line 4a). Such a speech path would accommodate assistance from a customer service representative in the update process, if necessary.

The user entity (UE) preferably acknowledges that a working data session is initiated (at line 5).

The trusted entity (TE) 18 will access the database 22, via the control module 104 and interface 108, to extract the new “downloadable” software available for this user entity (UE) 12 (at line 6). This step can be performed at any point in the session, and may be performed multiple times.

The trusted entity (TE) 18 and the user entity (UE) 12 will communicate through the respective interfaces, so the trusted entity (TE) 18 can extract data from the user entity (UE) 12 (at line 7). This will include (but is not limited to) extracting user database information which will be preserved and can later be re-installed (if needed) and contents of memory (e.g., state information, last known operation, etc.).

The trusted entity (TE) 18 will download the software updates to the application program module 56 of the user entity (UE) 12 through the interface 60 (at line 8).

The trusted entity (TE) 18 will execute the program to install the new software update(s) (at line 9). Once the installation is completed, the user may be requested to power cycle the user entity (UE) 12. This can be done via an icon or message on the UE.

The trusted entity (TE) 18 will also update, via the control module 104 and the interface 106, the application server (AS) 20 (which could be the same application sever (AS) as is running the trusted entity (TE) 18) with new software load information (at line 10). This will allow the application server (AS) 20 to track the software currently running on the user entity (UE) 12, and to automatically inform (or download) the user entity (UE) 12 of any changes that are mandatory.

Consequently, the application server (AS) 20 will store this information in the network database (at line 11).

Once all the software downloads are complete, the TE will repopulate the saved user data (at line 12).

The user entity (UE) 12 will preferably acknowledge the successful data download (at line 13).

To complete the process, the trusted entity (TE) will release control of the user entity (UE) 12 (at line 14). At this point, the user will gain control of the user entity (UE) 12. It is important to note that the user will also have the ability to abort the download throughout this process. This abort command can be via a soft button that appears on the display of the user entity (UE) 12. If the user elects to abort the download operation, the trusted entity (TE) will perform a “back-out” procedure to restore the user entity (UE) 12 to its previous state.

The trusted entity (TE) 18 will also remove the data connections (at line 15).

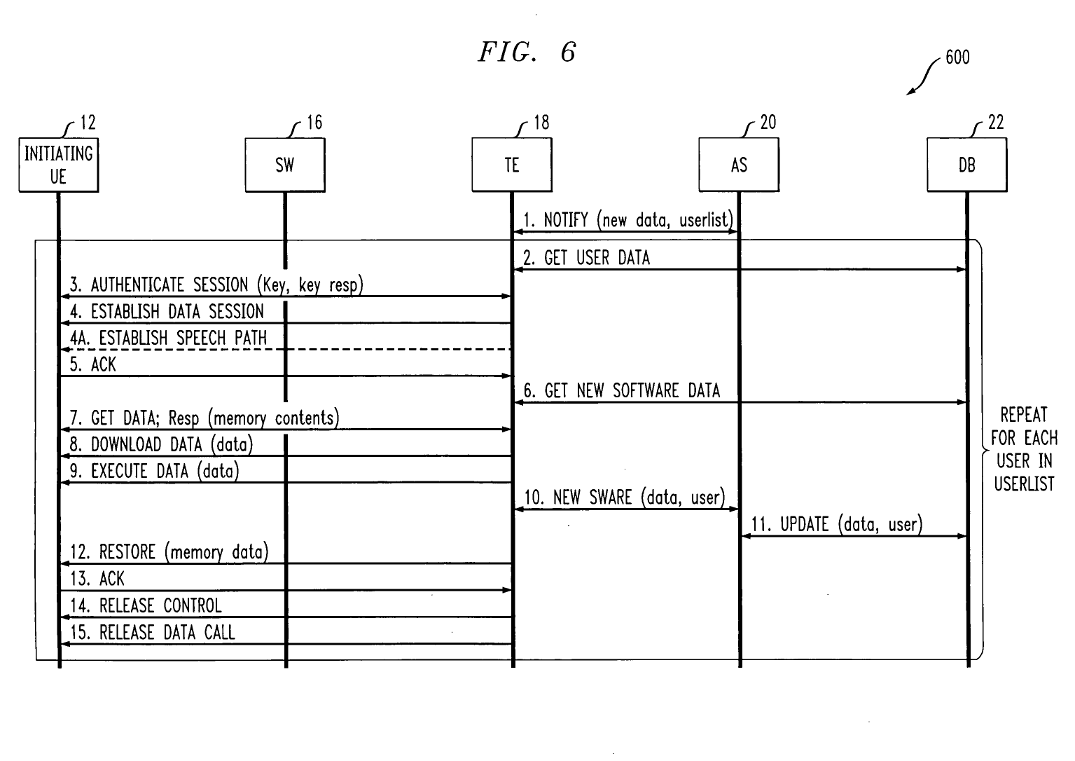

Referring now to FIG. 6, a call flow 600 is illustrated. This call flow is implemented where the application server (AS) 20 determines that a new software update must be downloaded to the user entity (UE) 12. The application server (AS) 20, through the interface 106, sends information to the trusted entity (TE) 18, identifying the software to be updated and the users that will be provided with this new update (at line 1). This could be new software that corresponds to new capabilities in the service provider's network. Additionally, this could be new software updates for things such as virus controls.

The trusted entity (TE) 18 accepts the “notify” message by the control module 104, and accesses the profile database 22, via the control module 104 and the interface 108, to obtain information about the user entity (UE) 12 (at line 2). This could be information such as manufacturer information, model information, user entity (UE) type, current software release information and/or authentication key information.

The trusted entity (TE) 18 authenticates the session with the user entity (UE) 12 and the user entity (UE) responds (at line 3). Of course, this is accomplished via authentication modules 62 and 102.

The trusted entity (TE) 18 establishes a data session (under control of control module 104) on which to perform the download to the user entity (UE) 12 (at line 4). It should be appreciated that a speech path may also be established to provide communication between the trusted entity (TE) 18 and the user entity (UE) 12 (at line 4a). Such a speech path would accommodate assistance from a customer service representative in the update process, if necessary.

The user entity (UE) 12 preferably acknowledges the initiation of a working data session (at line 5).

The trusted entity (TE) accesses, through the control module 104 and interface 108, the database 22 to extract the new “downloadable” software available for the user entity (UE) 12 (at line 6). This step can be performed at any point in the session, and may be performed multiple times.

The trusted entity (TE) 18 and user entity (UE) 12 will communicate through the respective interfaces, so the trusted entity (TE) 18 can extract data from the user entity (UE) 12 (at line 7). This will include (but is not limited to) extracting user database information which will be preserved and can later be re-installed (if needed) and contents of memory (e.g., state information, last known operation, etc.).

The trusted entity (TE) will download the software updates to the application program module 56 of the user entity (UE) 12 through the interface 60 (at line 8).

The trusted entity (TE) 12 will execute the program to install the new software update(s) (at line 9). If appropriate, the trusted entity (TE) 18 application could ask the user for accept/reject/the download. Once the installation is completed, the user may be requested to power cycle the user entity (UE) 12. This can be done via an icon or message on the user entity (UE) 12 (at 618).

The trusted entity (TE) 18 will update, through the interface 106, the application server (AS) 20 (which could be the same server as is running the TE) with new software load information (at line 10). This will allow the application server (AS) 20 to track the software currently running on the user entity (UE) 12, and to automatically inform (or download) the user entity (UE) 12 of any changes that are mandatory.

The application server (AS) 20 will in turn store this information in the network database 22 (at line 11).

Once all the software downloads are complete, the trusted entity (TE) 18 will repopulate the saved user data (at line 12).

The user entity (UE) 12 will acknowledge the successful data download (at line 13).

The trusted entity (TE) 18 will release control of the user entity (UE) 12 (at line 14). At this point, the user can gain control of the user entity (UE) 12. It is important to note that the user will have the ability to abort the download throughout this process. This abort command can be via a soft button that appears on the display of the user entity (UE) 12. If the user elects to abort the download operation, the trusted entity (TE) preferably performs a “back-out” procedure to restore the user entity (UE) to its previous state.

The trusted entity (TE) 18 will then remove the data connections (at line 15).

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. A method for wireless management of mobile entities comprising:
signaling a trusted entity to initiate a repair session by a user entity requiring repair;
obtaining user data on the user entity by the trusted entity;
authenticating identity of the trusted entity and the user entity for the repair session based on the user data;
establishing a speech path between the user entity and the trusted entity;
establishing a data path between the user entity and the trusted entity;
performing diagnostics on the user entity;
obtaining repair data based on the diagnostics;
repairing the user entity based on the repair data;
releasing the data path; and,
releasing the speech path.

2. The method as set forth in claim 1 wherein the signaling comprises manipulating one of a soft key and a hard key on the user entity.

3. The method as set forth in claim 1 wherein the obtaining user data comprises accessing a database.

4. The method as set forth in claim 1 wherein obtaining repair data comprises accessing a database.

5. A method for wireless management of mobile entities comprising:
signaling a trusted entity to initiate an update session by a user entity requiring update;
obtaining user data on the user entity by the trusted entity;
authenticating identity of the trusted entity and the user entity for the update session based on the user data;
establishing a data path between the user entity and the trusted entity;
obtaining update data;
downloading the update data to the user entity;
executing the update data downloaded to the user entity;
determining whether other update data should be downloaded;
restoring data on the user entity;
releasing the data path; and,
releasing the speech path.

6. The method as set forth in claim 5 further comprising
establishing a speech path between the user entity and the trusted entity.

7. The method as set forth in claim 5 wherein the signaling comprises manipulating one of a soft key and a hard key on the user entity.

8. The method as set forth in claim 5 wherein the signaling comprises notifying the trusted entity of an update session by an application server.

9. The method as set forth in claim 5 wherein obtaining user data comprises accessing a database.

10. The method as set forth in claim 5 wherein obtaining update data comprises accessing a database.

11. The method as set forth in claim 5 wherein obtaining update data comprises accessing an application server.

12. An apparatus for wireless management of mobile entities comprising:
means for signaling a trusted entity to initiate a repair session by a user entity requiring repair;
means for obtaining user data on the user entity by the trusted entity;
means for authenticating identity of the trusted entity and the user entity;
means for establishing a speech path between the user entity and the trusted entity;
means for establishing a data path between the user entity and the trusted entity;
means for performing diagnostics on the user entity;
means for obtaining repair data based on the diagnostics;
means for repairing the user entity;
means for releasing the data path; and,
means for releasing the speech path.

13. An apparatus as set forth in claim 12 wherein the means for signaling comprises one of a soft key and a hard key on the user entity.

14. An apparatus as set forth in claim 12 wherein the means for obtaining user data comprises means for accessing a database.

15. An apparatus as set forth in claim 12 wherein the means for obtaining repair data comprises means for accessing a database.

16. An apparatus for wireless management of mobile entities comprising:
means for signaling a trusted entity to initiate an update session by a user entity requiring update;
means for obtaining user data on the user entity by the trusted entity;
means for authenticating identity of the trusted entity and the user entity;
means for establishing a data path between the user entity and the trusted entity;
means for obtaining update data;
means for downloading the update data to the user entity;
means for executing the update data downloaded to the user entity;
means for determining whether other update data should be downloaded;
means for restoring data on the user entity;
means for releasing the data path; and,
means for releasing the speech path.

17. The apparatus as set forth in claim 16 further comprising means for establishing a speech path between the user entity and the trusted entity.

18. An apparatus as set forth in claim 16 wherein the means for signaling comprises one of a soft key and a hard key on the user entity.

19. An apparatus as set forth in claim 16 wherein the means for signaling comprises an application server.

20. An apparatus as set forth in claim 16 wherein the means for obtaining user data comprises means for accessing a database.

21. An apparatus as set forth in claim 16 wherein the means for obtaining update data comprises means for accessing a database.

22. An apparatus as set forth in claim 16 wherein the means for obtaining update data comprises means for accessing an application server.

23. A method for wireless management of mobile entities comprising:
receiving a signal by a trusted entity from a user entity to initiate a repair session by a user entity requiring repair;
obtaining user data on the user entity by the trusted entity;
authenticating identity of the trusted entity and the user entity for the repair session based on the user data;
establishing a speech path between the user entity and the trusted entity;
establishing a data path between the user entity and the trusted entity;
performing diagnostics on the user entity;
obtaining repair data based on the diagnostics;
repairing the user entity based on the repair data;
releasing the data path; and,
releasing the speech path.

24. A method for wireless management of mobile entities comprising:
receiving a signal by a trusted entity from a user entity to initiate an update session for a user entity requiring update;
obtaining user data on the user entity by the trusted entity;
authenticating identity of the trusted entity and the user entity for the update session based on the user data;
establishing a data path between the user entity and the trusted entity;
obtaining update data;
downloading the update data to the user entity;
executing the update data downloaded to the user entity;
determining whether other update data should be downloaded;
restoring data on the user entity;
releasing the data path; and,
releasing the speech path.

25. An apparatus for wireless management of mobile entities comprising:
means for receiving a signal to initiate a repair session by a user entity requiring repair;
means for obtaining user data on the user entity by a trusted entity;
means for authenticating identity of the trusted entity and the user entity;
means for establishing a speech path between the user entity and the trusted entity;
means for establishing a data path between the user entity and the trusted entity;
means for performing diagnostics on the user entity;
means for obtaining repair data based on the diagnostics;
means for repairing the user entity;
means for releasing the data path; and,
means for releasing the speech path.

26. An apparatus for wireless management of mobile entities comprising:
means for receiving a signal to initiate an update session by a user entity requiring update;
means for obtaining user data on the user entity by a trusted entity;
means for authenticating identity of the trusted entity and the user entity;
means for establishing a data path between the user entity and the trusted entity;
means for obtaining update data;
means for downloading the update data to the user entity;
means for executing the update data downloaded to the user entity;
means for determining whether other update data should be downloaded;
means for restoring data on the user entity;
means for releasing the data path; and,
means for releasing the speech path.
